(19) United States
(12) Patent Application Publication
(10) Pub. No.: US 2020/0406240 A1
(43) Pub. Date: Dec. 31, 2020

(54) LANTHANIDE-SUPPORTED TRANSITION METAL CATALYSTS AND USES THEREOF

(71) Applicant: Technology Innovation Momentum Fund (Israel) Limited Partnership, Tel Aviv (IL)

(72) Inventors: Brian Ashley Rosen, Tel Aviv (IL); Michael Gozin, Tel Aviv (IL); Moran Dahan, Tel Aviv (IL); Eswara Vara Prasadarao Komarala, Tel Aviv (IL); Ludmila Fadeev, Tel Aviv (IL); Ajay Kumar Chinnam, Tel Aviv (IL); Avital Shlomovich, Tel Aviv (IL)

(21) Appl. No.: 16/622,849

(22) PCT Filed: Jun. 14, 2018
(86) PCT No.: PCT/IL2018/050655

§ 371 Date: Dec. 13, 2019

Related U.S. Application Data
(60) Provisional application No. 62/519,996, filed on Jun. 15, 2017.

(51) Int. Cl. B01J 27/232; B01J 23/755; B01J 23/745; B01J 35/00; B01J 35/04; B01J 37/02; B01J 37/08; C01B 3/40

(52) U.S. Cl. CPC B01J 27/232; C01B 2203/1023; B01J 23/745; B01J 35/0013; B01J 35/0033; B01J 35/04; B01J 37/0217; B01J 37/0219; B01J 37/0236; B01J 37/088; B01J 37/086; C01B 3/40; C01B 2203/0233; C01B 2203/0238; C01B 2203/1241; C01B 2203/1082; C01B 2203/1058; C01B 2203/1047; B01J 23/755

(57) ABSTRACT

The present invention provides lanthanide-supported transition metal catalysts synthesized using high-nitrogen energetic precursors; processes for the preparation of said catalysts and for coating inert ceramic monoliths with said catalysts; and uses thereof, e.g., in reforming of methane.

### TECHNICAL FIELD

The present invention provides lanthanide-supported transition metal catalysts synthesized using high-nitrogen energetic precursors, and uses thereof, e.g., in reforming of methane.

Abbreviations: BTA, bis(1H-tetrazole-5-yl)amine; DRM, dry reforming of methane; DSC, differential scanning calorimetry; EDS, energy dispersive spectroscopy (nominal composition analysis and elemental dot mapping); FID, flame ionization detector; FTIR, Fourier-transform infrared; GHSV, gas hourly space velocity (hourly process gas flow per gram of catalyst); RT, room temperature; RWGS, reverse water-gas shift; sccm, standard cubic centimeters per minute; SEM, scanning electron microscopy; TCD, thermal conductivity detector; TEM, transmission electron microscopy; TGA, thermographic analysis; TPO, temperature program oxidation; TPR, temperature program reduction; TPR/O/R, temperature-programmed reduction, oxidation, and subsequent reduction; XPS, X-ray photoelectron spectroscopy (composition, oxidation states); XRD, X-ray diffraction (phase analysis).

### BACKGROUND ART

Nitrogen-rich energetic materials (EMs) belong to a class of compounds that can release a significant amount of energy and gasses upon their deflagration or detonation. These materials are commonly used as explosives, propellants, pyrotechnics, and as gas generators (Talawar et al., 2009). In recent years, nitrogen-rich EMs have undergone extensive research and development due to the capability of such materials to release N₂ as the main combustion product (“green” EMs).

During an investigation of the combustion behavior of various complexes of nitrogen-rich ligands for use in pyrotechnics, Tappan and coworkers found a novel way of synthesizing ultralow-density monolithic metal nanofoams (Tappan et al., 2010). This was achieved by self-propagating combustion of energetic metal complexes containing nitrogen-rich ligands. These researchers showed that the combustion behavior of the energetic metal complex played an important role in determining the metal nanofoam structure in an apparent “Goldilocks” effect. They found that energetic complexes that were too sensitive to mechanical impact and friction (“too hot”) detonated rapidly and failed to create monolithic foams, while complexes which were too inert (“too cold”) could not sustain a self-propagating combustion process. The use of such metal nanofoams in catalytic systems and other applications was recently reported. For example, gold nanofoams showed modest activity as electrocatalysts (Mueller et al., 2009), while self-combustion generated palladium nanofoams were investigated as a material for H₂ storage (Tappan et al., 2010). The latter Pd nanofoams showed a low capacity for storage of H₂ compared to bulk Pd metal (in a powdered form), possibly due to a presence of combustion-related impurities and residues. In addition to the synthesis of metal nanofoams, the only other reported use of high-nitrogen EMs for metal synthesis was from Qu and coworkers who made copper micro-rods by thermal decomposition of the Cu-[bis(1H-tetrazol-5-yl)amine]₂ (Cu(BTA)₂) complex under inert atmosphere (Qu et al., 2015).

DRM, the reforming of methane using CO₂, is considered to be a promising technology among several other processes for the reforming of methane (steam reforming, partial oxidation, autothermal reforming, etc.). One of the main interests in this process is due to the consumption of two major greenhouse gases (CO₂ and CH₄) by their conversion to synthesis gas (syngas), which is a mixture of CO and H₂ (Eq. 1) (Theofanidis et al., 2015; Baltrusaitis and Luyben, 2015; Shang et al., 2017; Littlewood et al., 2015).

CH₄+CO₂→2CO+2H₂, ΔH°_{298K}=+247 kJmol⁻¹ (eq. 1)

CH₄→C+2H₂, ΔH°_{298K}=+75 kJmol⁻¹ (eq. 2)

2 CO→CO₂+C, ΔH°_{298K}=−172 kJmol⁻¹ (eq. 3)

CO₂+H₂->CO+H₂O, ΔH°_{298K}=+41 kJmol⁻¹ (eq. 4)

The syngas produced from the DRM process could be further utilized as a starting material for Fischer-Tropsch reaction used for the production of various liquid hydrocarbons and fine chemicals. However, till now, the DRM technology is not heavily industrialized, due to the lack of availability of stable, efficient and economical catalysts (Li et al., 2011; Baudouin et al., 2012; Muraleedharan Nair and Kaliaguine, 2016).

Considering their cost, availability and activity, Ni-based catalysts, rather than catalysts containing some noble transition metals (such as ruthenium, rhodium, palladium, osmium, iridium and platinum) are most commonly used to promote the DRM process. On the other hand, Ni-based catalysts deactivate quite rapidly, due to coke formation and sintering, caused by CH₄ cracking (Eq. 2), CO dispersion (Boudouard reaction, Eq. 3), and high operational temperature. Different strategies for synthesis of supported Ni-based catalysts were reported (Dai et al., 2015; Kawi et al., 2015; Pakhare and Spivey, 2014; Pan and Bao, 2011; Prieto et al., 2013; Xie et al., 2014). For example, Singh et al. (2016) have synthesized shape-controlled LaNiO₃ nanoparticles and converted them into active Ni/La₂O₃ catalyst by a solid-crystallization method. These authors have shown that their catalyst is capable of a stable methane conversion for 100 hours at 650° C., without any carbon accumulation and sintering effects. Similarly, Li et al. (2017) have stabilized Ni nanoparticles on La₂O₂CO₃ nano-rods by wet impregnation method for DRM and reached a 70% stable methane conversion for 50 hours.

### SUMMARY OF INVENTION

The present specification discloses the unprecedented synthesis of a supported nanocatalyst prepared by the co-deflagration of a mixture of two high-nitrogen energetic metal complexes containing nickel and lanthanum. The term “co-deflagration” as used herein denotes the combustion of at least two metal-containing energetic complexes resulting in the sub-sonic release of gasses as well as a solid-phase product. As surprisingly found, the kinetic energy available to nickel and lanthanum atoms during the crystallization process gives rise to strong catalyst-support bonding and therefore stable catalytic activity. Ni/La₂O₂CO₃ and Ni/LaOCl were selected as our targets since they have a great potential to enable the large-scale industrialization of DRM, which is highly important due to its consumption of two green-house gasses. Additionally, the co-deflagration technique can be used to make catalysts for other industrial processes such as the water-gas shift reaction and the reverse water-gas shift reaction, potentially catalyzed by Fe/La₂O₂CO₃ or Fe₂O₃/La₂O₂CO₃.

In one aspect, the present invention relates to a lanthanum-N,N-bis(1H-tetrazole-5-yl)-amine (La-BTA) complex, e.g., the La-BTA pentahydrate complex exemplified herein.

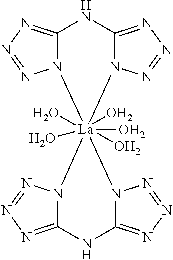

La-BTA Pentahydrate Complex

In another aspect, the present invention provides a catalyst, more specifically a supported catalyst, prepared by a combustion of a mixture of a lanthanum-BTA complex as defined above, and a transition metal (excluding lanthanides and actinides)-BTA complex, wherein the said supported catalyst comprises discrete particles each comprising a lanthanum-containing support material (i.e., core) and nanoparticles of said transition metal or oxide thereof, wherein said support material comprises lanthanum oxycarbonate in the form of both La₂O₂CO₃ and La₂O(CO₃)₂, and optionally lanthanum oxide (La₂O₃) and/or lanthanum oxychloride (LaOCl), and said nanoparticles are impregnated within or attached to said support material. A particular such supported catalyst exemplified herein comprises lanthanum oxycarbonate-based support material, and nanoparticles comprising nickel and nickel oxide, impregnated within or attached to said support material, wherein the amounts of said lanthanum oxycarbonate, nickel, and nickel oxide are about 50-52%, about 40-42%, and about 9-10%, by weight, of said supported catalyst, respectively. Such a catalyst exhibits an increase of about 0.8 eV in the binding energy of the Ni3p XPS spectrum, as compared to that of unbound (pure) Ni, indicating a formation of strong interactions between the nickel nanoparticles and the lanthanum oxycarbonate support, as a result of the kinetic energy imparted on the metal atoms during the combustion-based preparation of this catalyst. As further shown, while a pure Ni catalyst produced from the combustion of pure Ni-BTA suffered from severe sintering, the Ni/La oxycarbonate catalyst was found to be coke- and sintering-resistant after 100 h of catalytic activity, at various GHSVs. Said Ni/La oxycarbonate catalyst exhibited a high methane and carbon dioxide conversion rate of above 80% and with up to 150 L/g-h GHSV due to the strong interaction between the nickel and the lanthanum oxycarbonate support, and the relatively uniform distribution of the nickel nanoparticles on said support.

In yet another aspect, the present invention thus relates to methods for reforming of a hydrocarbon, e.g., an alkane such as methane, carried out in the presence of a catalyst as defined above. In one particular such aspect, the invention provides a method for dry reforming of said hydrocarbon, comprising reacting said hydrocarbon with carbon dioxide, in the presence of said catalyst, to thereby obtain hydrogen and carbon monoxide. In another particular such aspect, the invention provides a method for steam reforming of said hydrocarbon, comprising reacting said hydrocarbon with steam, in the presence of said catalyst, to thereby obtain hydrogen and carbon dioxide. In a further particular such aspect, the invention provides a method for mixed carbon dioxide and steam reforming of said hydrocarbon, comprising reacting said hydrocarbon with carbon dioxide and steam, in the presence of said catalyst, to thereby obtain hydrogen and carbon monoxide. In certain embodiments, the hydrocarbon reformed according to any one of the methods is a (C₁-C₈)alkane, preferably methane. In particular embodiments of each one of the methods, the transition metal is nickel, and the nanoparticles impregnated within or attached to said core comprise both nickel and nickel oxide.

In a further aspect, the present invention relates to a process for coating an inert ceramic monolith with a catalyst as defined above, said process comprising:
(i) activating the surface of said inert ceramic monolith, e.g., by cleaning said inert ceramic monolith with an acid such as nitric acid, sulfuric acid, hydrochloric acid, or acetic acid, and then optionally calcinating said inert ceramic monolith;
(ii) mixing said catalyst with a metal oxide, a polysaccharide, polyethylene glycol, a polyvinyl compound, and water to form a slurry;
(iii) coating the activated ceramic monolith with said slurry, e.g., by dipping said activated ceramic monolith in said slurry; and
(iv) drying and then calcinating the coated ceramic monolith.

In another aspect, the present invention provides a process for the preparation of a catalyst, more specifically a supported catalyst, comprising discrete particles comprising a lanthanide-based support material (i.e., a lanthanide-based core) and nanoparticles of a transition metal excluding lanthanides and actinides or an oxide thereof impregnated within or attached to said support material, said process comprising:
(i) mixing a complex of said lanthanide and an energetic nitrogen-rich ligand with a complex of said transition metal and the same or a different energetic nitrogen-rich ligand(s); and optionally an organic or inorganic oxidant, each in the form of a solid or semi-solid material, to obtain a homogeneous solid or semi-solid material;
(ii) optionally grinding and mixing said homogeneous solid or semi-solid material;
(iii) optionally pressing said homogeneous solid or semi-solid material into a form (pellet);
(iv) heating said optionally pressed homogeneous solid or semi-solid material at a temperature sufficient to combust said energetic nitrogen-rich ligand(s), but lower than the melting temperature of each one of said lanthanide and transition metal to thereby obtain a catalyst material;
(v) subjecting said catalyst material to a temperature sufficient to oxidize residual organic matter, but lower than the melting temperature of each one of said lanthanide and transition metal, in the flow of a gas mixture comprising O₂ and an inert gas selected from Ar, He or N₂; and
(vi) subjecting the product obtained in step (v) to a temperature sufficient to reduce the oxide of said transition metal obtained, but lower than the melting temperature of each one of said lanthanide and transition metal, in the flow of a gas mixture comprising O₂ and an inert gas selected from Ar, He or N₂, to thereby obtain said supported catalyst.

In one embodiment, the process disclosed herein is used for the preparation of a catalyst as defined above, i.e., a supported catalyst comprising discrete particles comprising a lanthanum-based support material, and nickel nanoparticles impregnated within or attached to said support material, wherein said process comprises: (i) mixing a La-BTA complex such as the La-BTA pentahydrate complex with a Ni-BTA complex and optionally an organic or inorganic oxidant, each in the form of a solid or semi-solid material, to obtain a homogeneous solid or semi-solid material; (ii) optionally grinding and mixing said homogeneous solid or semi-solid material; (iii) optionally pressing said homogeneous solid or semi-solid material into a form (pellet); (iv) heating said optionally pressed homogeneous solid or semi-solid material to about 350° C. to thereby combust said BTA ligand and said oxidant, if present, and consequently obtain a catalyst material; (v) subjecting said catalyst material to a temperature of about 400° C., in the flow of a gas mixture comprising O₂ and an inert gas selected from Ar, He or N₂, to thereby oxidize said lanthanum; and (vi) subjecting the product obtained in step (v) to a temperature of about 800° C., in the flow of a gas mixture comprising O₂ and an inert gas selected from Ar, He or N₂, to thereby reduce the nickel oxide obtained in step (iv) (when said homogeneous solid/semi-solid material is heated and ignites), and consequently obtain said catalyst.

In still another aspect, the present invention provides a catalyst, more specifically a supported catalyst, comprising discrete particles comprising a lanthanide-based support material (i.e., a lanthanide-based core), and nanoparticles of a transition metal excluding lanthanides and actinides or an oxide thereof impregnated within or attached to said support material, obtained by the process defined above.

Catalysts obtained by the process defined above can be used, e.g., for reforming of a hydrocarbon, e.g., an alkane such as methane. In yet another aspect, the present invention thus relates to methods for reforming of a hydrocarbon carried out in the presence of a catalyst as defined hereinabove, i.e., a catalyst comprising discrete particles comprising a lanthanide-based support material, and a transition metal nanoparticles impregnated within or attached to said support material. In one particular such aspect, the invention provides a method for dry reforming of said hydrocarbon, comprising reacting said hydrocarbon with carbon dioxide, in the presence of said catalyst, to thereby obtain hydrogen and carbon monoxide. In another particular such aspect, the invention provides a method for steam reforming of said hydrocarbon, comprising reacting said hydrocarbon with steam, in the presence of said catalyst, to thereby obtain hydrogen and carbon dioxide. In a further particular such aspect, the invention provides a method for mixed carbon dioxide and steam reforming of said hydrocarbon, comprising reacting methane with carbon dioxide and steam, in the presence of said catalyst, to thereby obtain hydrogen and carbon monoxide.

### BRIEF DESCRIPTION OF DRAWINGS

FIG. 1 shows the molecular structure of the La-BTA complex synthesized and selected crystallographic data for this compound.

FIGS. 2A-2B show SEM images of the Ni catalyst before (2A) and after (2B) oxidation, indicating that the carbon filaments disappeared after the oxidation of the catalyst.

FIG. 3 shows XRD pattern of the Ni/LaOCl catalyst after oxidation. The catalyst shows active Ni phase along with the support LaOCl with a minor NiO phase.

FIGS. 4A-B show SEM (4A) and high resolution TEM (4B) micrographs of the Ni/LaOCl catalyst. The impregnation of Ni nanoparticles in the LaOCl support is visible from the TEM micrographs.

FIG. 5 shows a SEM image of the Ni/LaOCl catalyst (panel a); and elemental mapping showing the distribution of Ni (panel b), La (panel c) Cl (panel d), and O (panel e) elements of said catalyst, indicating the formation of LaOCl support and the dispersion of Ni nanoparticles on it.

FIG. 6 shows XRD pattern of the Ni/La₂O₂CO₃ catalyst after oxidation/combustion (lower graph) and the XRD pattern of the Ni/La₂O₂CO₃ catalyst after 100 hours of methane dry reforming (upper graph).

FIG. 7 shows low magnification TEM (panel a) and high magnification TEM of the Ni/La₂O₂CO₃ catalyst where both the Ni and lanthanum oxycarbonate phases are visible (panel b); a SEM image of the Ni/La₂O₂CO₃ catalyst (panel c); and EDX elemental mapping of nickel (panel d), lanthanum (panel e) and oxygen (panel f).

FIG. 8 shows Ni3p XPS spectra of the Ni and Ni/LaOCl catalysts. The shift towards the higher binding energy indicates the strong interactions between the Ni and the LaOCl support.

FIG. 9 shows temperature-programmed experiments TPR-TPO-TPR in series of Ni/LaOCl catalysts showing the difference of pre- and post-oxidation. The experiments were carried out in 5% H₂ and O₂, respectively, in N₂, at a heating rate of 10° C./min.

FIGS. 10A-10C show a comparison of methane conversion (10A), CO₂ conversion (10B), and H₂:CO product ratio (10C) over Ni and Ni/LaOCl catalysts for dry reforming of methane at 800° C., 1:1:8 CH₄:CO₂:Ar, and a GHSV of 18.5, 30, 50, 100, 150 or 450 L/(g_{cat}·h).

FIGS. 11A-11C show a comparison of methane conversion (11A), CO₂ conversion (11B), and H₂:CO product ratio (11C) over 1 g of Ni/La₂O₂CO₃ powder catalysts for dry reforming of methane at 800° C., 1:1 CH₄:CO₂ with no dilutant and a GHSV of 18.5, 50, and 100 L/(g_{cat}·h)

FIG. 12. shows TGA of the Ni/La₂O₂CO₃ powder catalyst before and after 100 hours of methane dry reforming

FIGS. 13A-13C show a comparison of CH₄ conversion (13A), CO₂ conversion (13B), and H₂:CO product ratio (13C) over 1 g of Ni/La₂O₂CO₃ powder catalysts for dry reforming of methane at 800° C., 1:1 CH₄:CO₂ for 10 hours. After 10 hours, steam was added with no dilutant and a GHSV of 18.5, 50, and 100 L/(g_{cat}·h)

FIGS. 14A-14D show cordierite ceramic treated with 5 coats of Ni/La₂O₂CO₃ catalyst (14A), SEM image of pores in the cordierite ceramic after 5 coats of Ni/La₂O₂CO₃ catalyst along with a red line indicating the location of the EDX linescan (14B), and EDX linescan results for lanthanum (right to left) for lanthanum (14C) and nickel (14D).

FIGS. 15A-15C show a comparison of CH₄ conversion (15A), CO₂ conversion (15B), and H₂:CO product ratio (15C) over 0.5 g of Ni/La₂O₂CO₃ coated onto a ceramic cordierite carrier under dry reforming of methane at 800° C., 1:1 CH₄:CO₂ for 35 hours. After 35 hours, steam was added with no dilutant and a GHSV of 18.5, 50, and 100 L/(g_{cat}·h)

FIG. 16 shows a TEM micrograph of Ni/La₂O₂CO₃ after 100 h of methane dry reforming. Note how the particle is still firmly socketed into the support and there is no evidence for the accumulation of graphicit carbon or multi-walled carbon nanotube growth from the catalyst particle.

FIG. 17 shows a TEM micrograph of Fe₂O₃/La₂O₂CO₃ after combustion of the mixture La-BTA, Fe-BTA, and ammonium nitrate powders.

### DETAILED DESCRIPTION

In one aspect, the present invention relates to a lanthanum-N,N-bis(1H-tetrazole-5-yl)-amine (La-BTA) complex. In a particular embodiment, said La-BTA complex is in pentahydrate form as exemplified herein.

In another aspect, the present invention provides a catalyst comprising discretem i.e., separate or distinct, particles each comprising a lanthanum-containing support material and nanoparticles of a transition metal excluding lanthanides and actinides or an oxide thereof, wherein said support material comprises lanthanum oxycarbonate (both La₂O₂CO₃ and La₂O(CO₃)₂) and optionally lanthanum oxide and/or lanthanum oxychloride, and said nanoparticles are decorating said support material, more specifically impregnated within or attached to said support material. The term “lanthanum oxycarbonate” as used herein refers to both La₂O₂CO₃ and La₂O(CO₃)₂. Accordingly, catalysts of the present invention referred to herein (for the sake of simplicity) as metal/La₂O₂CO₃ or metal/La₂O(CO₃)₂, e.g., Ni/La₂O₂CO₃ or Ni/La₂O(CO₃)₂, comprise in all cases discrete particles comprising said metal/lanthanum oxycarbonate- and optionally said metal/La₂O₃— and/or said metal/LaOCl-based support material. Similarly, the term “lanthanum oxycarbonate-based support material” or “lanthanum oxycarbonate-based core” as used herein interchangeably refers to a support material (core) comprising, or made of, lanthanum oxycarbonate and optionally one or both of lanthanum oxide and lanthanum oxychloride.

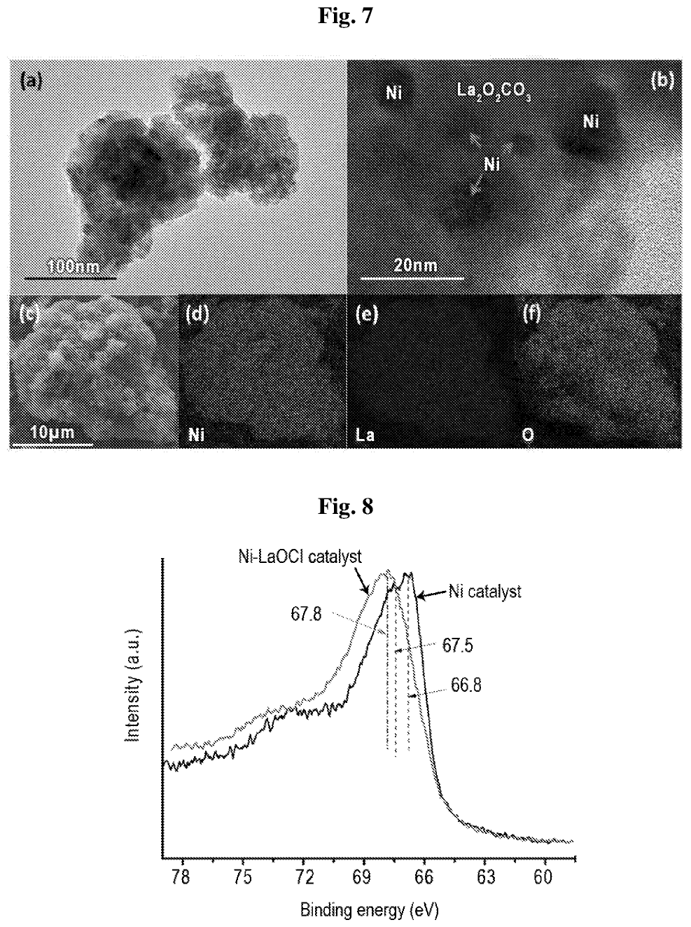

According to the present invention, the support material composing the catalyst, i.e., the particle core, is decorated, rather than completely coated or covered, by the transition metal nanoparticles, as shown, e.g., in FIG. 7 showing TEM and SEM images of the Ni/La₂O₂CO₃ catalyst. The distribution of the nanoparticles decorating the support material may vary depending on the various conditions of the combustion synthesis and post-combustion treatment, used for the preparation of the catalyst, and in certain cases said nanoparticles are uniformly, or in fact relatively uniformly, distributed over the lanthanum oxycarbonate-based support material.

In certain embodiments, the catalyst of the present invention does not comprise molecular carbon. The term “molecular carbon” as used herein denotes a compound consisting solely of carbon atoms, including macromolecules such as fullerenes; carbon nanomaterials such as single-walled carbon nanotubes, multi-walled carbon nanotubes, or graphene; carbon microstructures such as vitreous carbon; carbon polymorphic forms such as graphite; and amorphous carbon.

In certain embodiments, the nanoparticles impregnated within or attached to the lanthanum oxycarbonate-based support material comprise both said transition metal and said oxide thereof. In other embodiments, said nanoparticles comprise either said transition metal or said oxide thereof.

The term “transition metal” as used herein refers to any element in the d-block (columns 3 through 12) of the Periodic Table, excluding the lanthanides (the elements with atomic numbers from 57 to 71) and the actinides (the elements with atomic numbers from 89 to 103). Examples of transition metals include, without being limited to, titanium (Ti), vanadium (V), manganese (Mn), iron (Fe), cobalt (Co), nickel (Ni), copper (Cu), zinc (Zn), molybdenum (Mo), ruthenium (Ru), rhodium (Rh), palladium (Pd), tungsten (W), rhenium (Re), osmium (Os), iridium (Ir), or platinum (Pt). In certain embodiments, the transition metal is nickel or iron.

The term “impregnated” as used herein with respect to the transition metal nanoparticles means that said nanoparticles are not only attached to the support material but, could be partially or completely imbedded within said lanthanum oxycarbonate-based support material, as a result of the combustion process used for the preparation of the catalyst.

In certain embodiments, the transition metal nanoparticles impregnated within or attached to the lanthanum oxycarbonate-based support material are relatively uniformly distributed on said support material.

In certain embodiments, the present invention provides a catalyst as defined in any one of the embodiments above, wherein said transition metal is nickel; and (a) the overall amount of said lanthanum oxycarbonate, lanthanum oxide and lanthanum oxychloride is about 45-60%, preferably about 50-55%, more preferably about 50-52%, by weight, of said catalyst; (b) the amount of said nickel is about 35-50%, preferably about 40-45%, more preferably about 40-42%, by weight, of said catalyst; or (c) the amount of said nickel oxide, when present, is about 5-15%, preferably about 8-12%, more preferably about 9-10%, by weight, of said catalyst. In particular such embodiments, the amounts of said lanthanum oxycarbonate (including lanthanum oxide and/or lanthanum oxychloride, when present), nickel, and nickel oxide are about 50-52%, about 40-42%, and about 9-10%, by weight, of said catalyst, respectively, e.g., about 50.0%, 50.1%, 50.2%, 50.3%, 50.4%, 50.5%, 50.6%, 50.7%, 50.8%, 50.9%, 51.0%, 51.1%, 51.2%, 51.3%, 51.4%, 51.5%, 51.6%, 51.7%, 51.8%, 51.9% or 52.0% lanthanum oxycarbonate (including lanthanum oxide and/or lanthanum oxychloride, when present); about 40.0%, 40.1%, 40.2%, 40.3%, 40.4%, 40.5%, 40.6%, 40.7%, 40.8%, 40.9%, 41.0%, 41.0%, 41.1%, 41.2%, 41.3%, 41.4%, 41.5%, 41.6%, 41.7%, 41.8%, 41.9%, or 42.0% nickel; and about 9.0%, 9.1%, 9.2%, 9.3%, 9.4%, 9.5%, 9.6%, 9.7%, 9.8%, 9.9% or 10.0% nickel oxide, by weight, of said catalyst, wherein each combination of these amounts represents a separate embodiment. Particular such catalysts exhibit an increase of about 0.8 eV or more, e.g., about 0.8 eV, about 0.85 eV, about 0.9 eV, about 0.95 eV, about 1.0 eV, about 1.05 eV, about 1.1 eV, or more, in the binding energy of the Ni3p XPS spectrum compared to that of unbound Ni.

As shown herein, the Ni/La₂O₂CO₃ catalyst of the present invention is highly efficient in dry reforming of methane at 800° C., exhibiting excellent catalytic activity at GHSVs, as high as 150 L/g-h, without any coking and sintering even after 100 hours of activity. As discussed in the Experimental section herein, this unexpected stability probably results from the kinetic energy imparted onto the metal atoms during the combustion synthesis used for the preparation of the catalyst; and it seems to be due to strong interaction between the nickel and the lanthanum-based support, as evident from the increase in the binding energy of the Ni3p XPS spectrum compared to that of unbound nickel, which leads to relatively uniform distribution of the nickel nanoparticles formed on the lanthanum oxide/oxychloride support material, and to impregnation of at least part of said nickel nanoparticles into the support material. The strength of the interaction is also supported by the lack of multi-walled carbon nanotube growth after 100 h of methane dry reforming, a catalyst deactivation mechanism typical of weakly bound Ni nanoparticles.

In yet another aspect, the present invention thus relates to methods for reforming of a hydrocarbon, e.g., an alkane such as methane, carried out in the presence of the catalyst of the invention as defined in any one of the embodiments above. The term “alkane” as used herein means a linear or branched hydrocarbon having, e.g., 1-8 carbon atoms and includes methane, ethane, n-propane, isopropane, n-butane, sec-butane, isobutane, tert-butane, n-pentane, isopentane, 2,2-dimethylpropane, n-hexane, n-heptane, n-octane, and the like. In one particular such aspect, disclosed herein is a method for dry reforming of said hydrocarbon, comprising reacting said hydrocarbon with carbon dioxide as the oxidizing agent, in the presence of said catalyst, so as to crack said hydrocarbon into a H₂+CO mixture, which may then be used in a gas-to-liquid conversion for the production of hydrocarbon fuels and other materials. In another particular such aspect, disclosed herein is a method for steam reforming of said hydrocarbon, comprising reacting said hydrocarbon with steam, in the presence of said catalyst, to thereby obtain hydrogen and carbon dioxide. In a further particular such aspect, disclosed herein is a method for mixed dry and steam reforming of said hydrocarbon, comprising reacting said hydrocarbon with both carbon dioxide and steam as the oxidizing agents, in the presence of said catalyst, so as to crack said hydrocarbon into a H₂+CO mixture, which may then be used in a gas-to-liquid conversion for the production of hydrocarbon fuels and other materials. In certain embodiments, the hydrocarbon reformed according to any one of the methods is a (C₁-C₈)alkane, preferably methane. In particular embodiments of each one of the methods, said transition metal is nickel, and the nanoparticles impregnated within or attached to said core comprise both nickel and nickel oxide.

In a further aspect, the present invention relates to a process for coating an inert ceramic monolith with a catalyst as defined above, said process comprising: (i) activating the surface of said inert ceramic monolith; (ii) mixing said catalyst with a metal oxide; a polysaccharide; a polyalkylene glycol, more specifically polyethylene glycol; a polyvinyl compound; and water to form a slurry; (iii) coating the activated ceramic monolith with said slurry; and (iv) drying and then calcinating the coated ceramic monolith.

In certain embodiments, the inert ceramic monolith coated by the process disclosed herein is alumina such as γ-Al₂O₃, cordierite, mullite, or silicon carbide.

The activation of the inert ceramic monolith in step (i) of the process is necessary to make sure that the monolith's surface is available and contaminant-free, prior to coating with the catalyst. In certain embodiments, the inert ceramic monolith is activated by cleaning with an acid such as nitric acid, sulfuric acid, hydrochloric acid, or acetic acid, but preferably with nitric acid, and then optionally calcinating at a temperature in a range of 500-1600° C.

In certain embodiments, the metal oxide mixed with said catalyst in step (ii) of the process is alumina such as γ-Al₂O₃, colloidal alumina, pseudoboehmite, silica, colloidal silica, or sodium silicate. In preferred embodiments, said metal oxide is alumina such as γ-Al₂O₃.

In certain embodiments, the polysaccharide mixed with said catalyst in step (ii) of the process is hydroxyalkyl cellulose such as hydroxypropyl cellulose and hydroxyethyl cellulose. In preferred embodiments, said polysaccharide is hydroxypropyl cellulose.

In certain embodiments, the polyethylene glycol mixed with said catalyst in step (ii) of the process has a molecular weight in a range of about 600 dalton (Da) to about 6000 Da. In preferred embodiments, said polyethylene glycol has a molecular weight of about 6000 Da.

In certain embodiments, the polyvinyl compound mixed with said catalyst in step (ii) of the process is polyvinyl alcohol, polyvinyl pyrrolidone, polyvinyl butyral, or polyvinyl chloride. In preferred embodiments, said polyvinyl compound is polyvinyl alcohol.

In certain embodiments, the activated ceramic monolith is coated with said slurry in step (iii) by dipping in said slurry.

In particular embodiments, the inert ceramic monolith is activated in step (i) by cleaning with nitric acid; the metal oxide mixed with said catalyst in step (ii) is alumina, e.g., γ-Al₂O₃; the polysaccharide mixed with said catalyst in step (ii) is hydroxypropyl cellulose; the polyethylene glycol mixed with said catalyst in step (ii) has a molecular weight of about 6000 Da; said polyvinyl compound mixed with said catalyst in step (ii) is polyvinyl alcohol; and the activated ceramic monolith is coated with said slurry in step (iii), e.g., by dipping in said slurry. In more particular such embodiments, the inert ceramic monolith is activated in step (i) by cleaning with nitric acid and then calcinated at about 550° C.; the concentration of the alumina mixed in step (ii) is 0.1-10%, preferably 1-3%, by weight; the concentration of the hydroxypropyl cellulose mixed in step (ii) is 0.01-5%, preferably 0.3-1%, by weight; the concentration of the polyethylene glycol mixed in step (ii) is 0.01-5%, preferably 0.1-0.5%, by weight; and the concentration of the polyvinyl alcohol mixed in step (ii) is 0.01-5%, preferably 0.1-0.5%, by weight.

In a particular such aspect, the present invention relates to a process for coating an inert ceramic monolith with a catalyst as defined in any one of the embodiments above, wherein said transition metal is nickel, i.e., a process for coating an inert ceramic monolith with a catalyst comprising discrete particles comprising lanthanum oxycarbonate- and optionally lanthanum oxide- and/or lanthanum oxychloride-core, and nanoparticles of nickel or an oxide thereof impregnated within or attached to said core.

In another aspect, the present invention provides a process for the preparation of a catalyst, more specifically a supported catalyst, comprising discrete particles comprising a lanthanide-based core, and nanoparticles of a transition metal excluding lanthanides and actinides or an oxide thereof impregnated within or attached to said core, said process comprising: (i) mixing a complex of said lanthanide and an energetic nitrogen-rich ligand with a complex of said transition metal and the same or a different energetic nitrogen-rich ligand(s); and optionally an organic or inorganic oxidant, each in the form of a solid or semi-solid material, to obtain a homogeneous solid or semi-solid material; (ii) optionally grinding and mixing said homogeneous solid or semi-solid material; (iii) optionally pressing said homogeneous solid or semi-solid material into a form (pellet); (iv) heating said optionally pressed homogeneous solid or semi-solid material at a temperature sufficient to combust said energetic nitrogen-rich ligand(s), but lower than the melting temperature of each one of said lanthanide and transition metal to thereby obtain a catalyst material; (v) subjecting said catalyst material to a temperature sufficient to oxidize residual organic matter, but lower than the melting temperature of each one of said lanthanide and transition metal, in the flow of a gas mixture comprising (more specifically consisting of) O₂ and an inert gas selected from Ar, He or N₂; and (vi) subjecting the product obtained in step (v) to a temperature sufficient to reduce the oxide of said transition metal obtained, but lower than the melting temperature of each one of said lanthanide and transition metal, in the flow of a gas mixture comprising (more specifically consisting of) O₂ and an inert gas selected from Ar, He or N₂, to thereby obtain said catalyst.

According to the process of the present invention, an organic or inorganic oxidant is optionally mixed in step (i) with the lanthanide complex of energetic nitrogen-rich ligand(s) and the transition metal complex of the same or different energetic nitrogen-rich ligand(s), depending on the particular lanthanide and transition metal complexes used. The amount of such an organic or inorganic oxidant mixed with the lanthanide and transition metal complexes may be up to about 70%, by weight, of the overall solid powder mixture, e.g., up to about 10%, up to about 15%, up to about 20%, up to about 25%, up to about 30%, up to about 35%, up to about 40%, up to about 45%, up to about 50%, up to about 55%, up to about 60%, up to about 65%, or up to about 70%, by weight, of the overall solid powder mixture. Non-limiting examples of inorganic oxidants include ammonium nitrate, ammonium dinitramide, and ammonium perchlorate; and examples of organic oxidants include, without being limited to, peroxides, trinitromethane salts, 2,2,2-trinitroethanol and derivatives thereof, 2,2-dinitromethane and salts and derivatives thereof, and 2,2-dinitroethanol and salts and derivatives thereof.

The term “lanthanide” as used herein refers to any one of the series of fifteen metallic elements from lanthanum to lutetium in the Periodic Table, also known as “rare earth elements”, i.e., lanthanum (La), cerium (Ce), praseodymium (Pr), neodymium (Nd), promethium (Pm), samarium (Sm), europium (Eu), gadolinium (Gd), terbium (Tb), dysprosium (Dy), holmium (Ho), erbium (Er), thulium (Tm), ytterbium (Yb), and lutetium (Lu). In particular embodiments, the lanthanide used for the preparation of the supported catalyst according to the process of the present invention is La, Ce, Pr, Nd, Pm, Sm, or Gd. In a more particular such embodiment, said lanthanide is La.

In certain embodiments, the energetic nitrogen-rich ligand(s) being complexed with either or both the lanthanide or transition metal, according to the process disclosed herein, is selected from triazole, tetrazole, N,N-bis(1H-tetrazole-5-yl)-amine (BTA), 5,5-diazotetrazolate triazole, tetrazine, nitramines, guanidines, guanylureas, nitroguanidines, nitroureas, or aminoguanidines.

According to the process of the present invention, the lanthanide and transition-metal complexes, optionally together with an organic or inorganic oxidant, are heated at a temperature sufficient to combust the energetic nitrogen-rich ligand(s); and then subjected to a temperature sufficient to oxidize residual organic matter. The supported catalyst obtained by this process thus comprises very low amounts of carbon or carbon-containing materials, and in certain embodiments, does not comprise carbon or carbon-containing materials at all.

In certain embodiments, the lanthanide complex used according to the process of the present invention is a La-BTA complex, e.g., the La-BTA pentahydrate complex, and the transition metal complex used is a Ni-BTA complex.

In certain embodiments, the process of the invention as defined in any one of the embodiments above is used for the preparation of a catalyst as disclosed herein, i.e., a supported catalyst comprising discrete particles comprising a lanthanum-based support material and nickel nanoparticles impregnated within or attached to said support material, wherein said process comprises: (i) mixing a La-BTA complex such as the La-BTA pentahydrate complex with a Ni-BTA complex and optionally an organic or inorganic oxidant, each in the form of a solid or semi-solid material, to obtain a homogeneous solid or semi-solid material; (ii) optionally grinding and mixing said homogeneous solid or semi-solid material; (iii) optionally pressing said homogeneous solid or semi-solid material into a form (pellet); (iv) heating said optionally pressed homogeneous solid or semi-solid material to about 350° C. to thereby combust said BTA ligand and said oxidant, if present, and consequently obtain a catalyst material; (v) subjecting said catalyst material to a temperature of about 400° C., in the flow of a gas mixture comprising O₂ and an inert gas selected from Ar, He or N₂, to thereby oxidize said lanthanum; and (vi) subjecting the product obtained in step (v) to a temperature of about 800° C., in the flow of a gas mixture comprising O₂ and an inert gas selected from Ar, He or N₂, to thereby reduce the nickel oxide obtained and consequently obtain said catalyst.

In particular embodiments, the La-BTA complex used for the preparation of said catalyst is the La-BTA pentahydrate complex; and up to 70%, by weight of the overall solid or semi-solid material mixture, organic or inorganic oxidant, as defined above is optionally added to the complexes mixture.

In still another aspect, the present invention provides a catalyst, more specifically a supported catalyst, comprising discrete particles comprising a lanthanide-based core, and nanoparticles of a transition metal excluding lanthanides and actinides or an oxide thereof impregnated within or attached to said core, wherein said catalyst is obtained by the process of the present invention as defined in any one of the embodiments above. Such a catalyst can be used, e.g., for reforming of a hydrocarbon, e.g., an alkane such as methane.

In yet another aspect, the present invention relates to methods for reforming of a hydrocarbon, e.g., an alkane such as methane, carried out in the presence of a catalyst as defined hereinabove, i.e., a catalyst comprising discrete particles comprising a lanthanide-based support material, and transition metal nanoparticles impregnated within or attached to said support material. In one particular such aspect, the invention provides a method for dry reforming of said hydrocarbon, comprising reacting said hydrocarbon with carbon dioxide, in the presence of said catalyst, to thereby obtain hydrogen and carbon monoxide. In another particular such aspect, the invention provides a method for steam reforming of said hydrocarbon, comprising reacting said hydrocarbon with steam, in the presence of said catalyst, to thereby obtain hydrogen and carbon dioxide. In a further particular such aspect, the invention provides a method for mixed carbon dioxide and steam reforming of said hydrocarbon, comprising reacting said hydrocarbon with carbon dioxide and steam, in the presence of said catalyst, to thereby obtain hydrogen and carbon monoxide. In certain embodiments, the hydrocarbon reformed according to any one of the methods is a (C₁-C₈)alkane, preferably methane. In particular embodiments of each one of the methods, said transition metal is nickel, and the nanoparticles impregnated within or attached to said core comprise both nickel and nickel oxide.

Unless otherwise indicated, all numbers referring, e.g., to amounts of lanthanum oxycarbonate, lanthanum oxide, or lanthanum oxychloride, nickel, and nickel oxide in the supported catalyst disclosed herein, or to temperatures used in the process of the invention, used in the present specification are to be understood as being modified in all instances by the term “about”. Accordingly, unless indicated to the contrary, the numerical parameters set forth in this description and claims are approximations that may vary by up to plus or minus 10% depending upon the desired properties sought to be obtained by the invention.

The invention will now be illustrated by the following non-limiting Examples.

### Examples

### Study 1. Synthesis and Characterization of Ni-Lanthanum Oxychloride and Ni-Lanthanum Oxycarbonate Catalysts

### Experimental

Bis(1H-tetrazole-5-yl)amine [BTA]

(U.S. Pat. No. 5,468,866). A solution of boric acid (10.14 g, 164.0 mmol), sodium dicyanamide (7.4 g, 83.1 mmol) and NaN₃ (10.8 g, 166.1 mmol) in water (80 mL) was refluxed for 18 h, while the pH was kept at about 8. The reaction mixture was then cooled to RT and acidified by dropwise addition of concentrated hydrochloric acid to pH 1. Formed white precipitate was collected by filtration, washed with water (until pH 3) and vacuum dried to yield pure BTA as a white powder (5.8 g, 46% yield). FTIR (ATR): 495, 1043, 1554, 1645, 2361, 2853, 2941, 3027, 3453 cm⁻¹. DSC (10° C./min)—endotherms: 120.2 and 138.7° C.; exotherm: 244.2° C.

### Ammonium 5,5′-azanediylbis(tetrazol-1-ide) [ammonium-BTA]

(U.S. Pat. No. 8,350,050). To a dispersion of BTA (6.0 g, 39.2 mmol) in water (100 mL) ammonia solution (28% in water) was added dropwise at RT until a transparent solution was obtained. The resulted solution was evaporated on a rotovap (at 60° C.) and further vacuum dried to yield pure ammonium-BTA as a white powder (6.7 g, 93% yield). FTIR (ATR): 473, 520, 977, 1631, 2164, 2284, 3157, 3392 cm⁻¹. DSC (10° C./min)—endotherms: 115.5, 132.7° C.; exotherms: 253.1, 278.3, 332.1, 536.2° C.

Ni-BTA Complex

(U.S. Pat. No. 7,141,675). A solution of ammonium-BTA (3.03 g, 16.2 mmol) and Ni(ClO₄)₂.6H₂O (2.96 g, 8.1 mmol) in water (50 mL) was refluxed for 12 h under vigorous stirring. After that time, the reaction mixture was allowed to cool down to RT, a solvent was evaporated on a rotovap (at 60° C.) and further vacuum dried to yield Ni-BTA complex as a violet powder (5.5 g). FTIR (ATR): 744, 824, 1041, 1303, 1597, 3195 cm⁻¹. DSC (10° C./min)—endotherm: 243.9° C.; exotherms: 366.6, 566.6° C.

La-BTA Complex.

A solution of ammonium-BTA (3.03 g, 16.2 mmol) and La(NO₃)₃.6H₂O (3.51 g, 8.1 mmol) in water (50 mL) was refluxed for 12 h under vigorous stirring. After that time, the reaction mixture was allowed to cool down to RT, a solvent was evaporated on a rotovap (at 60° C.) and further vacuum dried to yield La-BTA complex as a white powder (2.3 g). FTIR (ATR): 626, 716, 1424, 1511, 1622, 2320, 3099 cm⁻¹. DSC (10° C./min)—endotherms: 91.1, 149.9° C.; exotherms: 285.7, 328.5° C.

Ni Catalyst.

Powder of Ni-BTA (250 mg) was grinded in an agate mortar and pressed into a pellet, by using 13 mm die (suitable for preparation of pellets for FTIR) and 100 kN hydraulic press. The pellet obtained was placed into a stainless-steel autoclave and heated in a furnace at 300° C. for 1 h. After combustion, the catalyst powder was collected, placed into a quartz tube (with diameter 2.54 cm) in a tube oven, and oxidized at 400° C. for 4 h at 100 sccm flow of Ar and O₂ gas mixture. Subsequently, the oxidized catalyst powder was reduced at 800° C. for 1 h at 25 sccm flow of Ar and H₂ gas mixture.

Ni/LaOCl Catalyst.

Powders of Ni-BTA and ammonium perchlorate (171.0 mg), and La-BTA (85.5 mg) were mixed and grinded together in an agate mortar to obtain a homogeneous solid. This solid was grinded in an agate mortar and pressed into a pellet, by using 13 mm die and 100 kN hydraulic press. The obtained pellet was placed into a stainless-steel autoclave and heated in a furnace at 300° C. for 1 h. After combustion, the catalyst powder (45.7 mg, 18% yield) was collected, placed into a quartz tube in a tube oven, and oxidized at 400° C. for 4 h at 100 sccm flow of Ar and O₂ gas mixture, to produce oxidized Ni/LaOCl catalyst (29.5 mg, 11.5% yield). Subsequently, the oxidized catalyst powder was reduced at 800° C. for 1 h at 25 sccm flow of Ar and H₂ gas mixture.

Ni/LaO₂CO₃ Catalyst.

Powders of Ni-BTA and ammonium nitrate (171.0 mg), and La-BTA (85.5 mg) were mixed and grinded together in an agate mortar to obtain a homogeneous solid. This solid was grinded in an agate mortar and pressed into a pellet, by using 13 mm die and 100 kN hydraulic press. The obtained pellet was placed into a stainless-steel autoclave and heated in a furnace at 300° C. for 1 h. After combustion, the catalyst powder (45.7 mg, 18% yield) was collected, placed into a quartz tube in a tube oven, and oxidized at 400° C. for 4 h at 100 sccm flow of Ar and O₂ gas mixture, to produce oxidized Ni/LaO₂CO₃ catalyst (29.5 mg, 11.5% yield). Subsequently, the oxidized catalyst powder was reduced at 800° C. for 1 h at 25 sccm flow of Ar and H₂ gas mixture.

Characterization Techniques.

The BTA ligand and metal-BTA complexes were characterized by FTIR spectroscopy and DSC, powder XRD and single-crystal X-ray diffraction. The Ni and Ni/LaO₂CO₃ catalysts were characterized by electron microscopy, powder XRD, XPS, TPR and TPO. The DSC data was recorded by Netzsch Simultaneous Thermal Analyzer (STA) 449 F5 Jupiter. FTIR spectra were taken using Bruker Tensor 27 spectrometer, equipped with an ATR unit and recorded using Opus software. Electron micrographs were taken using field-emission gun Environmental scanning electron microscope (Quanta 200 FEG ESEM) and field-emission gun transmission electron microscope (Tecnai, Philips) operated at 200 kV. XRD pattern was recorded on Scintag-powder diffractometer equipped with liquid nitrogen cooled germanium solid state detector with Cu Kα radiation. XPS analysis of the catalyst was performed on 5600 AES/XPS system (PHI, USA) using Al Kα (hν=1486.6 eV) as the excitation source. A shift of −1.05 and 0.4 eV in Ni3p XPS spectra of Ni and Ni/LaOCl catalysts respectively were considered during analysis. The TPR and TPO were recorded by a PulsarBET gas analyzer (Quantachrome) instrument. Further, the catalysts prepared were placed at the center of a quartz tube (11 mm or 50 mm ID) on either a quartz wool or a cordierite support. Before testing the catalytic activity, the catalysts were reduced at 800° C. for 1 h at 25 sccm of Ar and H₂ gas flows. The dry reforming performance of the catalysts was tested under different GHSV viz. 18.5, 30, 50, 100, 150 and 450 L/(g·h). The catalytic reaction was initiated by feeding a mixture of CH₄ and CO₂ with a molar ratio of unity over the catalyst. The mixed reforming activity was measured using the same procedure as described above, except with the additional feed of H₂O with a molar ratio between 0.1 and 0.5 compared to the inlet CO₂ flow. The conversion of methane and carbon dioxide into carbon monoxide and hydrogen was monitored using an SRI gas chromatograph fitted with MS-13X and Haysep-C packed columns. Hydrogen was detected using a nitrogen carrier and TCD detector. CO₂, CO and CH₄ were detected by a FID detector with a methanizer placed directly upstream.

### Results and Discussion

Characterization of Ni and Ni/LaO₂CO₃ and LaOCl Catalysts

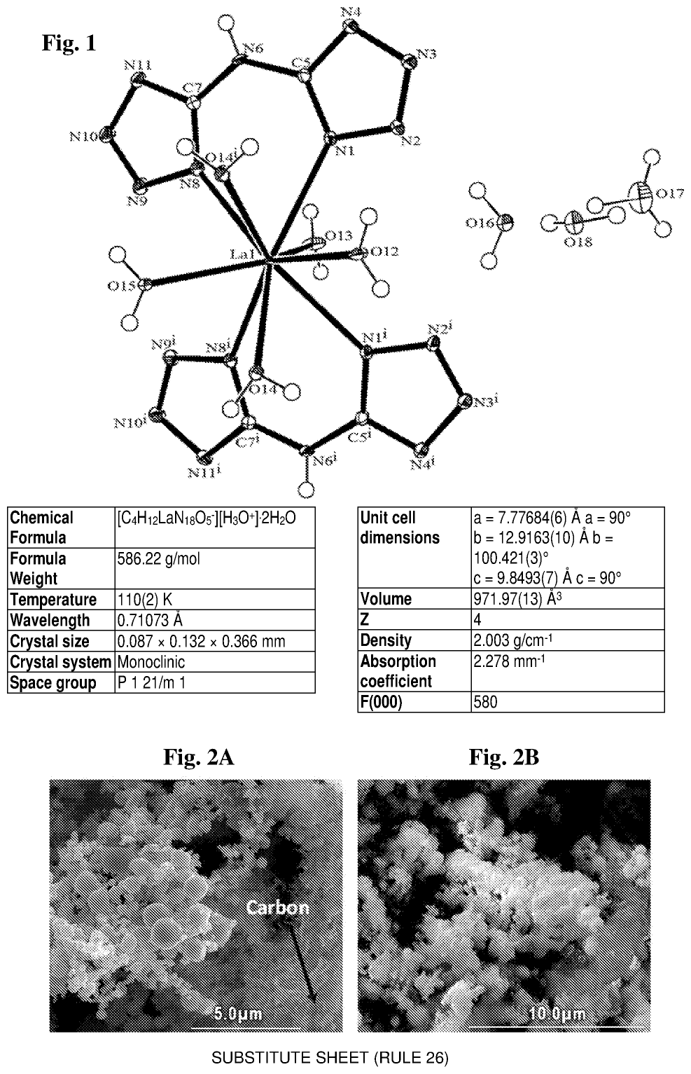

FIG. 1 shows the results of single-crystal x-ray diffraction of the La-BTA complex. Both BTA bidentate ligands in the complex are bound symmetrically to the La metal center and are oriented in a planar fashion within the ligand and one to another. In addition to two BTA ligands, out of five La(III)-coordinated water molecules, four are located on the same side of the plane, formed by BTA ligands. The La-BTA complex is crystalized in its acidic form (La-containing moiety is negatively charged −1), accompanied by a single hydronium cation and two non-coordinated water molecules.

Combustion synthesis was used to prepare the Ni and Ni/LaOCl catalysts. FIG. 2 shows the SEM micrographs of the Ni catalyst immediately after the combustion process and after the oxidation (cleaning) step. FIG. 2A shows that carbon, in the form of filaments, is accumulated after the combustion process due to the remnants of the energetic complex BTA; and FIG. 2B shows that the oxidation process removes the carbon form the catalyst. Hence, before testing for their catalytic activity, the catalysts were oxidized to avoid the carbon accumulation.

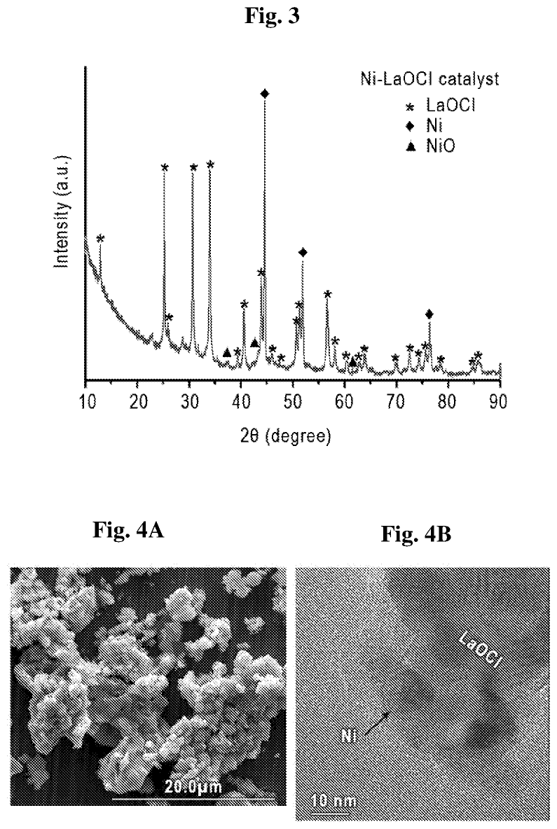

FIG. 3 shows the XRD pattern of the Ni/LaOCl catalyst after oxidation. The XRD pattern shows that the catalyst consists of three different crystalline phases: LaOCl (tetragonal, P4/nmm, JCPDS 97-008-4330), Ni (cubic, Fm-3m, JCPDS 97-005-2231) and NiO (monoclinic, C2/m, JCPDS 04-006-6160). The structural characteristic parameters of each phase of the catalyst are given in Table 1. The crystallite sizes were calculated from Debye-Scherrer formula and are given as 51.7, 91.6 and 32.4 nm for LaOCl, Ni and NiO phases, respectively. The phase composition reveals that about 50 wt % of the catalyst consists of support phase LaOCl in which the Ni nanoparticles (about 40 wt %) are present. The additional NiO phase present in the sample probably results from the oxidation process (to remove the carbon remnants of BTA) done after the combustion of the catalyst.

TABLE 1
Lattice parameters, crystallite size and phase identification
of the Ni/LaOCl catalyst

| | | | | Avg. | |
|---|---|---|---|---|---|
| | | | | crystallite | Phase |
| | Lattice parameters (nm) | | | size | composition |
| Phase | a | b | c | (nm) | (%) |
| LaOCl | 0.412 | 0.412 | 0.687 | 51.7 | 50.4 |
| Ni | 0.352 | 0.352 | 0.352 | 91.6 | 40.4 |
| NiO | 0.512 | 0.295 | 0.296 | 32.4 | 9.2 |

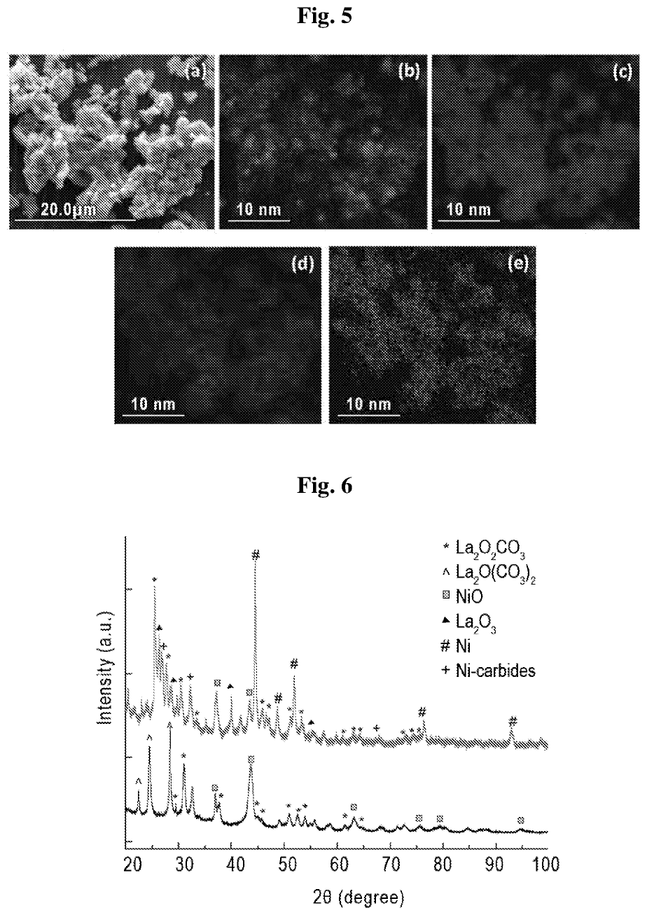

The morphology of the Ni/LaOCl catalyst was seen in both SEM and TEM. FIGS. 4A and 5 show the SEM image and the corresponding elemental mapping of the catalyst. The elemental mapping clearly shows the formation of LaOCl phase as a support and the Ni nanoparticles dispersed on the support.

FIG. 4B shows the high resolution TEM image of the Ni/LaOCl catalyst demonstrating that the dark contrasted Ni particles (indicated by a circle, size: 10-12 nm) are impregnated tightly into the LaOCl support. The Ni nanoparticles were identified by measuring the lattice spacing (2.04 Å) using inverse fast Fourier transform (FFT) of the circled region of FIG. 4B. Such kind of embedded nanosized Ni particles in to the support with strong interactions helps the catalyst to exhibit high catalytic performance without suffering from coking and sintering.

FIG. 5 shows the SEM image and the corresponding elemental mapping of the catalyst. The elemental mapping clearly shows the formation of LaOCl phase as a support and the Ni nanoparticles dispersed on the support.

TABLE 2
crystallite size and phase identification of the Ni/LaO₂CO₃
catalyst

| | Avg. crystallite size | Phase composition |
|---|---|---|
| | determined by | determined by |
| Phase | TEM (nm) | XRD (%) |
| La₂O₂CO₃ | 95 | 51 |
| Ni | 10 | 40 |
| NiO | 12.5 | 9 |

FIG. 6 shows XRD of the Ni/LaO₂CO₃ catalyst before and after methane dry reforming for 100 h. We see that the as-prepared catalyst consists of a lanthanum oxycarbonate support impregnated with NiO. After reaction, we see that some Ni carbides form, although they do not appear to negatively impact performance.

FIG. 7 shows TEM and SEM-EDX micrographs of the supported catalyst formed as a result of the co-deflagration of the La-BTA with Ni-BTA mixture. At low magnification (panel a), clusters of particles with light contrast approximately 120 nm in diameter are observed. At higher magnification (panel b), it is clear that these light-contrast particles are themselves dispersed with smaller dark-contrast nanoparticles approximately 10-15 nm in diameter. Based on the lattice spacing and localized EDX, these small dark nanoparticles are identified as nickel oxide (PDF 04-011-2340). While the exact composition of the support cannot be resolved by measuring lattice spacing in TEM, XRD revealed that the lanthanum-based support is composed of two different types of lanthanum oxycarbonate (PDF 00-048-1113 and PDF 00-032-0490) (FIG. 6). The formation of the oxycarbonate phases are intriguing because it may have been thought that upon deflagration, carbon in the BTA structure oxidizes to carbon dioxide and is expelled from the system along with nitrogen. The fact that the oxycarbonate phase is observed as the support means that CO₂ generated during the combustion was incorporated into the solid structure

The chemical changes of Ni in both the Ni and Ni/LaOCl catalysts were analyzed by XPS (data not shown). Compared to that of the Ni catalyst, the XPS of the Ni/LaOCl catalyst not only exhibits a relatively low intensity O1s and Ni peaks, but also exhibits additional peaks corresponding to La phase, which confirms the interactions of Ni with La phase. The spectra do not exhibit any carbon peak which implies that the oxidation process completely removes the carbon accumulation of the catalyst. According to standard energy positions, the peaks of Ni2p and La₃d overlap strongly and it is thus not possible to analyze the Ni2p peak in both of the catalysts (Liang and Xiaofang, 2011). Therefore, we use Ni3p core levels to see the chemical changes of Ni in both of the catalysts (FIG. 8). The two peak positions at 66.8 and 67.5 eV in the Ni catalyst correspond to Ni²⁺3p_{3/2} and Ni—Cl bonds respectively (U.S. Pat. No. 5,468,866). The Cl might be coming from the Ni precursor (Ni(ClO₄)₂.6H₂O) for making the Ni-BTA complex. However, in the case of the Ni/LaO₂CO₃ or Ni/LaO₂(CO₃)₂ catalyst, the shoulder peak disappears and a significant shift towards a higher binding energy is observed. The shift indicates that there is a strong interaction between the Ni and the La LaO₂CO₃ or LaOCl support during the combustion process. The interactions are strong enough to make the Ni nanoparticles impregnated into the La LaO₂CO₃ support as is evident from XRD (FIGS. 3 and 6) and elemental mapping (FIGS. 5 and 7) of the Ni/La LaO₂CO₃ catalyst.

Temperature Programmed Reduction and Oxidation of Ni/La LaO₂CO₃ Catalyst

FIG. 9 shows the profiles of three temperature-programmed experiments done in series of TPR-TPO-TPR of Ni/La LaO₂CO₃ catalyst. The second TPR done after TPO is named as post-TPR. TPR exhibits a peak at around 450° C. and a broad curve till 800° C. indicating that most of the nickel oxide (formed after the oxidation step intended to clean the catalyst of residual carbon from the combustion) is reduced to metallic Ni at 450° C. and a complete reduction can be observed at 800° C. After TPR, the same material was oxidized via TPO in order to compare its initial reduction to a reduction process done after high temperature oxidation (e.g. redox cycling) The post-TPR curve shows that there were two types of nickel present in the catalyst sample: 1) the TPR peak at 450° C. shows that some nickel did not sufficiently interact with the LaO₂CO₃ support and its reduction is simply represented by an NiO reduction peak in the same position as the first TPR scan. 2) the peaks after 600° C. evidence that the rest of the Ni in the catalyst had strong interactions with the LaO₂CO₃ support and therefore formed a mixed metal oxychloride phase during the oxidation (TPO) process. This mixed metal oxychloride (containing both La and Ni ions) is subsequently reduced via multiple steps—each step representing a reduction of the Ni ion until it is fully metallic at 1100° C.

### Catalytic Performance of the Ni and Ni/LaOCl Catalysts

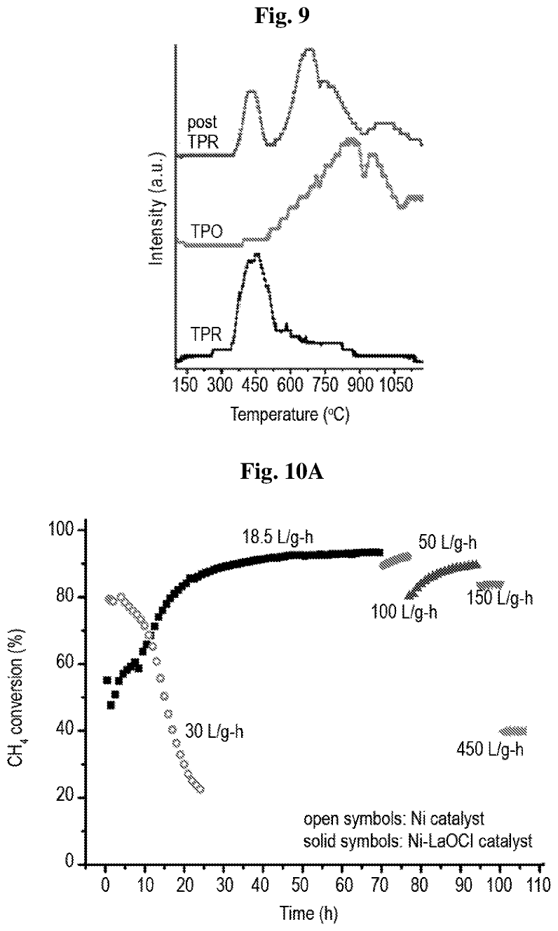

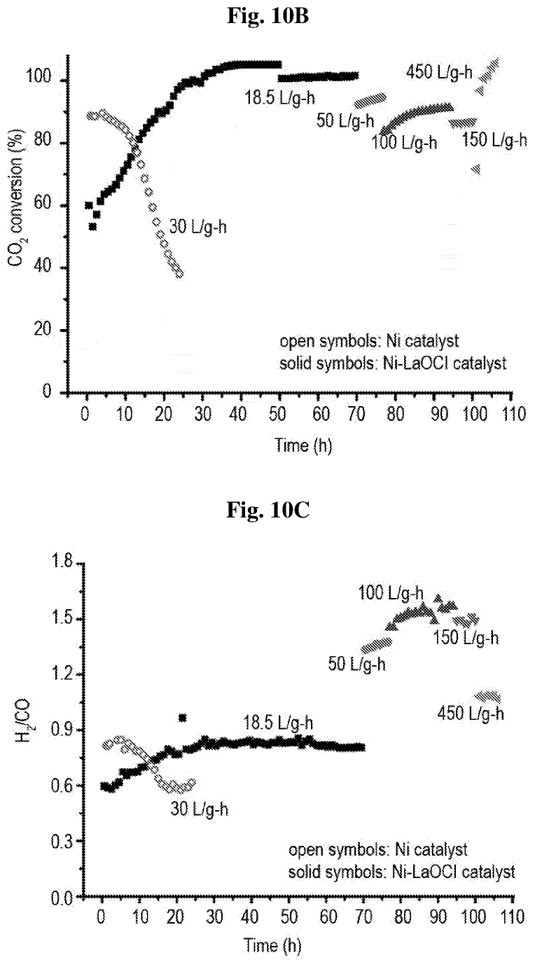

The catalytic activity and stability of the catalysts were carried out at 800° C. as a thought of avoiding carbon formation from Boudouard reaction (Eq. 3) and the RWGS reaction (Eq. 4) which causes a decrease in H₂/CO ratio (Fan et al., 2009). The DRM activity was tested at different GHSVs (18.5 L/g-h to 450 L/g-h). FIG. 10 shows the catalytic performance of the Ni and Ni/LaOCl catalysts as a function of time at various GHSVs. Only the flow rates of carbon dioxide and methane are considered in the calculation of GHSV. The initial (6-7 h) conversions of the Ni catalyst (open symbols) for CH₄ and CO₂ were 80% and 90%, respectively; however, the conversion decreased with time and reached 22% and 38%, respectively, after 24 h, due to the fact that pure Ni catalysts without a support suffer from severe sintering effects.

To encounter the problem of sintering with the Ni catalyst, we have synthesized Ni/LaOCl catalyst. At lower GHSV (18.5 L/g-h), the Ni/LaOCl catalyst exhibits a high CH₄ and CO₂ conversion rates of ˜90% and ˜100%, respectively, and is stable for more than 60 h of time. To check the catalytic performance capability of the Ni/La LaO₂CO₃ catalyst, we have increased the GHSVs from 18.5 to 450 L/g-h (closed symbols). The Ni/LaOCl catalyst shows >80% conversion rates of both CH₄ and CO₂ up to 150 L/g-h GHSV. However, the CH₄ conversion rate decreased to 40% at very high GHSV of 450 L/g-h. In contrast, the CO₂ conversion rate reached beyond 100% at the highest GHSV. Also, the observed H₂/CO ratio at GHSVs 18.5 and 450 L/g-h were much lower than that of the remaining GHSVs. A similar effect in the opposite direction can be observed for CO₂ conversion rates at different GHSVs. The observed low H₂/CO ratio and the high CO₂ conversion rates at 18.5 and 450 L/g-h GHSVs are the adverse effects of RWGS reaction in which most of the CO₂ and produced H₂ were utilized to form CO and water (Múnera et al., 2007; Tsipouriari and Verykios, 2001). Although the catalytic activity is performed at 800° C., the RWGS effects can be still observed. Depending upon the standard free energies, Wang et al. (1996) concluded that the RWGS and Boudouard reactions will not take place at temperatures above 820° C. On the other hand, the stability of the Ni/LaOCl catalyst over 100 h of catalytic activity can be explained on the basis of the La support. The effect of La support on the catalytic activity of Ni-based catalysts has been elevated in various reports (Singh et al., 2016; Li et al., 2017; Oemar et al., 2016; Ma et al., 2016). For example, Sierra Gallego et al. (2008) proposed that during DRM process of Ni/La₂O₃, the exposed CO₂ gas is adsorbed on La₂O₃ and forms La₂O₂CO₃. Further, the excellent oxidizing characteristics of the formed oxycarbonate benefit to gasify the dissociated carbon (due to CH₄ decomposition) at catalyst and produce CO and H₂.

Catalytic Performance and Post-Reaction Characterization of the Ni/La₂O₂CO₃ Catalyst

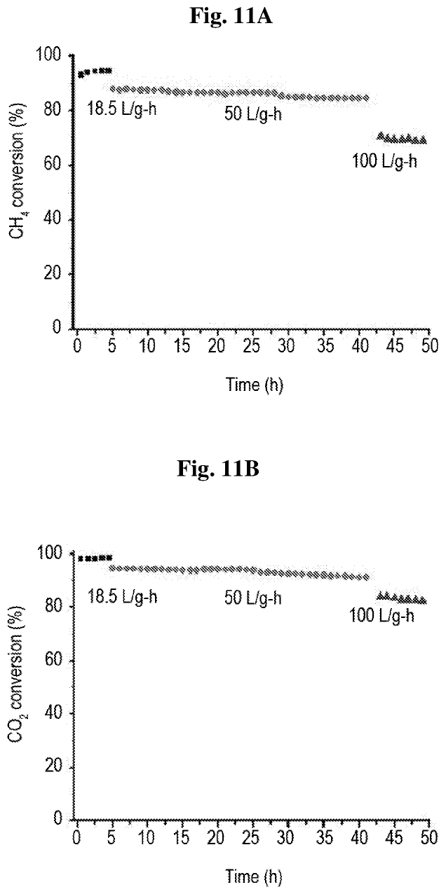

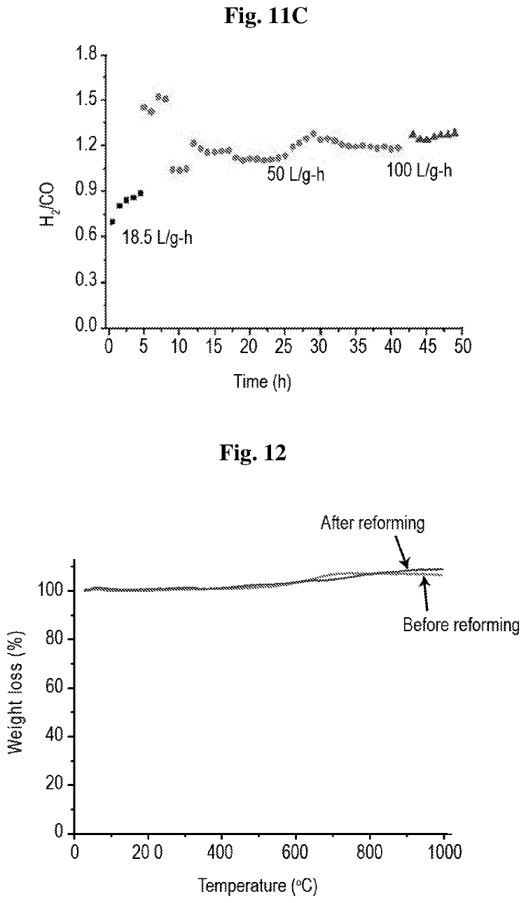

FIG. 11 shows catalytic DRM activity and stability of the Ni/La₂O₂CO₃ catalyst powder at 800° C. The DRM activity was tested at different GHSVs (18.5 L/g-h to 100 L/g-h). Only the flow rates of carbon dioxide and methane are considered in the calculation of GHSV. Similar to the Ni/LaOCl catalyst described above, the Ni/La₂O₂CO₃ is also able to maintain high methane and carbon dioxide conversions despite the significant increase in the space velocity of inlet gas.

FIG. 12 shows TGA of fresh and spent (100 h of dry reforming) catalyst in an oxygen environment up to 1000° C. If carbon were to accumulate on our catalyst during the dry reforming process, it would be indicated by mass loss while it was oxidized to CO/CO₂ during the TGA experiment. FIG. 12 shows that the TGA profile of the catalyst after 100 h of dry reforming is identical to the fresh catalyst, with no region of significant mass lost. This result points to the stability of our catalyst under the harsh reaction conditions of methane dry reforming as no bulk carbon deposits were found.

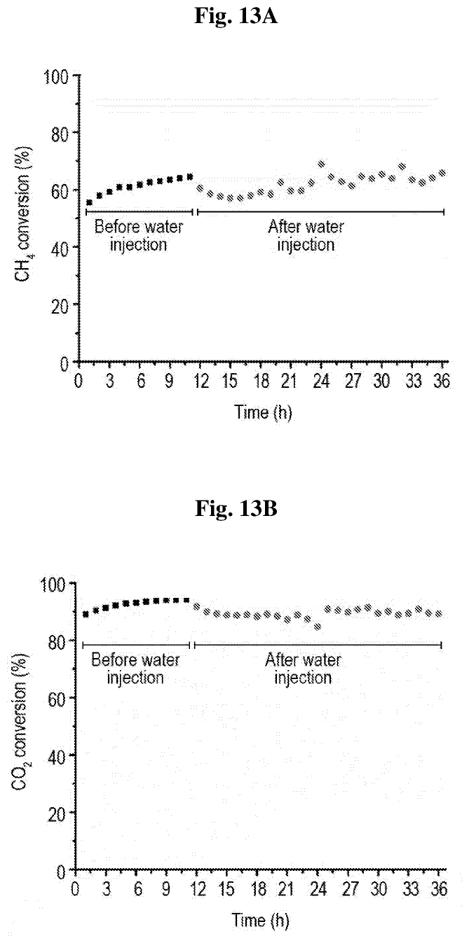

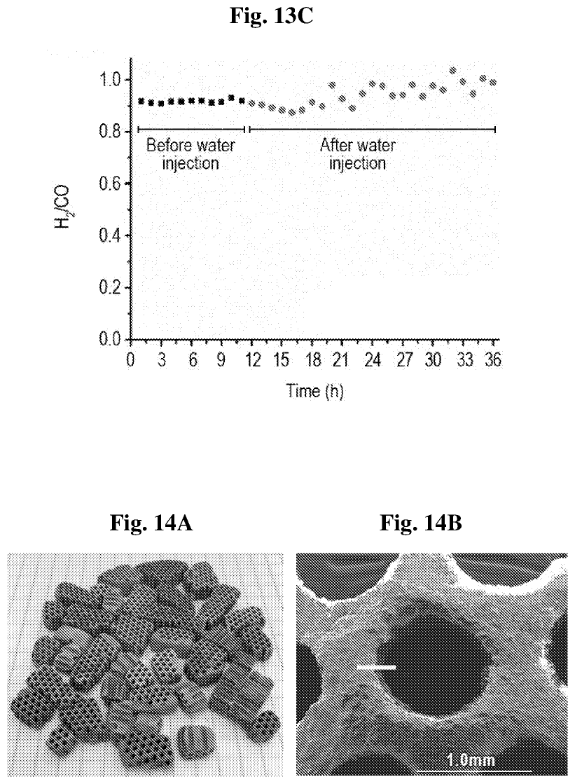

The catalytic performance of Ni/La₂O₂CO₃ powder was also monitored during an injection of water. The purpose of this test is to validate that the catalyst continues to perform even in moist carbon dioxide is used, and additionally to validate that this catalyst is viable for use in mixed carbon dioxide and steam reforming. FIG. 13 shows the methane and carbon dioxide conversion as well as the product ratio for typical dry reforming at 2-bar for 10 hours. After 10 hours, water was injected at a molar ratio of 1:10 with the molar flow rate of CO₂. FIGS. 13A-B show that the conversion is stable despite the addition of water. Furthermore, FIG. 13C shows that the hydrogen product ratio increases.

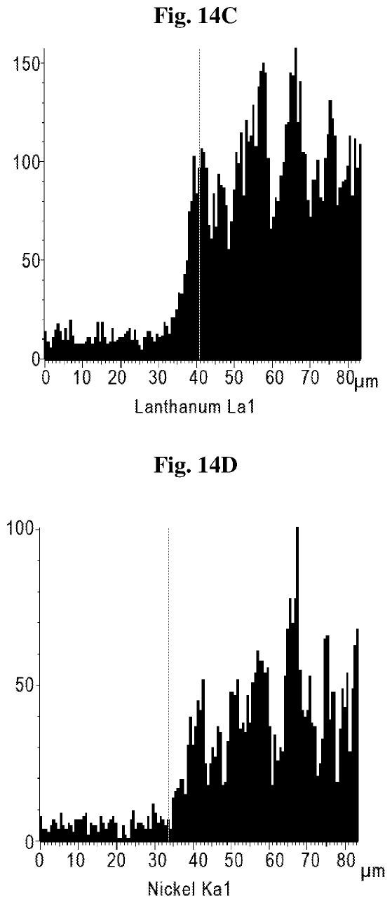

Since most industrial reactors are not packed with powder catalyst as shown in FIGS. 4 and 7, there is significant interest towards developing a procedure to coat a porous inert ceramic carrier approximately 5 mm in size with our catalyst particles. FIG. 14A shows commercially available cordierite coating with the Ni/La₂O₂CO₃.

To coat, the Cordierite was activated by cleaning the support in 1M nitric acid for 2 hours and then calcinating at 550° C. for 4 h. The slurry was prepared by adding 3 wt % of catalyst into deionized water and sonicating for 30 min. An additional 3 wt % of alumina nanoparticles was added to the slurry and the entire mixture was re-sonicated. To this slurry, 0.6 wt % of hydroxyl propyl cellulose and 0.3 wt % of polyethylene glycol and 0.3 wt % of polyvinyl alcohol was added. This mixture was stirred for 2 hours. To form a single coat, the activated Cordierite pieces were dipped in this slurry for 5 min and dried at 100° C. for 3 hours, then calcinated at 600° C. for 6 hours.

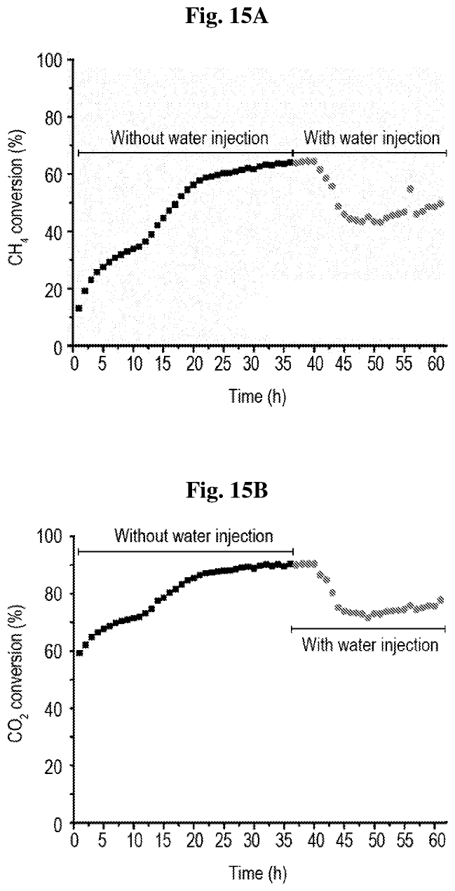

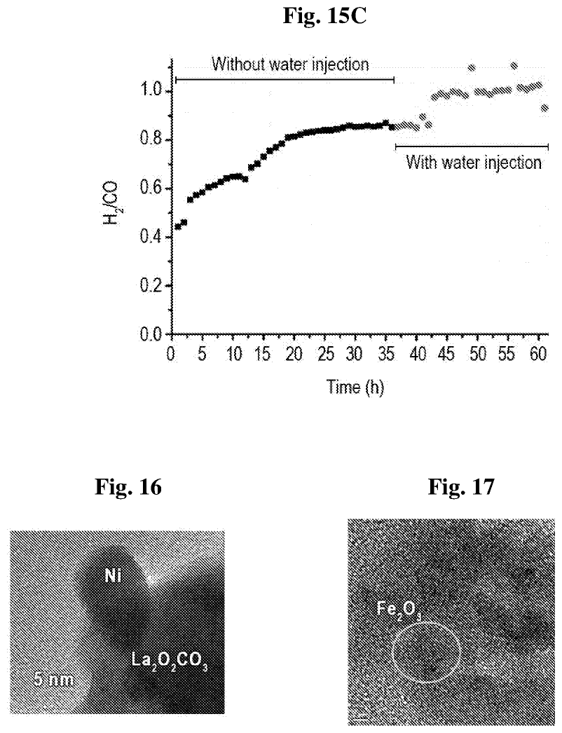

FIG. 14B shows a SEM image of the coated cordierite pore along with a line representing the location of the linescan elemental analysis. From the EDX elemental analysis (FIGS. 14C-D), we see that Ni/La₂O₂CO₃ catalyst was successfully applied to the cordierite based on the relative abundance of Ni and La. Finally, 250 mg of Ni/La₂O₂CO₃ catalyst was coated onto Cordierite pieces and tested for methane dry reforming. These pieces were loaded into a 50 mm diameter plug flow reactor and fed methane and carbon dioxide at a total flow of 5 L/g-h. FIG. 15 shows the performance of the Ni/La₂O₂CO₃ coated cordierite under dry reforming conditions for 35 hours. After 35 hours, water was injected to simulate mixed methane and steam reforming. While the initial shock of the water injection led to a decrease in conversion, it is clear that the conversion of methane and carbon dioxide is able to recover (FIGS. 15A-B). Predictably, the water injection led to an increase in hydrogen production as shown in FIG. 15C.

The morphological changes of Ni/La₂O₂CO₃ catalyst after 100 hours of methane dry reforming were observed through TEM. As shown in FIG. 16, the Ni nanoparticles are still firmly held by their support and have shown no sign of ripening or sintering. Furthermore, it is clear from the TEM image that neither graphite nor multi-walled carbon nanotubes accumulated on the catalyst or support surface.

### CONCLUSIONS

Combustion synthesis of energetic metal complexes was performed to prepare the new Ni/LaO₂CO₃ catalyst. This synthetic method produced Ni nanoparticles, which were successfully impregnated into the LaO₂CO₃ support, as shown by TEM along with minor NiO phase. The temperature-programmed experiments with the catalyst reveal existence of different kinds of Ni particles and their interactions with the support. The newly developed catalyst was found to be highly promising for dry reforming of methane at 800° C., while the Ni nanoparticles catalyst without support, suffered from severe sintering. The Ni/La LaO₂CO₃ catalyst exhibited excellent catalytic activity at GHSVs as high as 150 L/g-h, without any coking and sintering even after 100 h of activity. The better stability of the Ni—La BTA catalyst was explained on the basis of formation of Ni nanoparticles and their strong interaction with the La LaO₂CO₃ support.

Study 2. Synthesis and Characterization of Fe₂O₃/La₂O₂CO₃

A solution of ammonium-BTA (3.03 g, 16.2 mmol) and iron nitrate in water (50 mL) was refluxed for 12 h under vigorous stirring. After that time, the reaction mixture was allowed to cool down to room temperature, a solvent was evaporated on a rotovap (at 60° C.) and further vacuum dried to yield Fe-BTA complex as a black powder. Fe-BTA powder was mixed with La-BTA and ammonium nitrate and compressed into a pellet in a similar manner to the pellet used to produce Ni/La₂O₂CO₃. The pellet was ignited under air at 350° C. to result in Fe₂O₃/La₂O₂CO₃ catalyst. FIG. 17 is a TEM image showing an iron oxide particle imbedded in the surrounding oxycarbonate. Upon reduction in hydrogen, the iron oxide particle is readily reduced to metallic iron.

### REFERENCES

Ajamein, H.; Haghighi, M., Energy Conversion and Management, 2016, 118, 231-242
Baltrusaitis, J.; Luyben, W. L., ACS Sustainable Chemistry & Engineering, 2015, 3, 2100-2111
Baudouin, D.; Szeto, K. C., Laurent, P.; De Mallmann, A.; Fenet, B.; Veyre, L.; Rodemerck, U.; Copéret, C.; Thieuleux, C., Journal of the American Chemical Society, 2012, 134, 20624-20627
Dai, C.; Zhang, S.; Zhang, A.; Song, C.; Shi, C.; Guo, X., Journal of Materials Chemistry A, 2015, 3, 16461-16468
Fan, M.-S.; Abdullah, A. Z.; Bhatia, S., Chem Cat Chem, 2009, 1, 192-208
Gao, H.; Shreeve, J. n. M., Chemical Reviews, 2011, 111, 7377-7436
He, L.; Tao, G.-H.; Parrish, D. A., Shreeve, J. n. M., Chemical Communications, 2013, 49, 10329-10331
Joo, Y.-H.; Shreeve, J. n. M., Angewandte Chemie International Edition, 2010, 49, 7320-7323
Kawi, S.; Kathiraser, Y.; Ni, J.; Oemar, U.; Li, Z.; Saw, E. T., Chem Sus Chem, 2015, 8, 3556-3575
Li, Y.-C.; Qi, C.; Li, S.-H.; Zhang, H.-J.; Sun, C.-H.; Yu, Y.-Z.; Pang, S.-P., Journal of the American Chemical Society, 2010, 132, 12172-12173
Li, D.; Nakagawa, Y.; Tomishige, K., Applied Catalysis A: General, 2011, 408, 1-24
Li, X.; Li, D.; Tian, H.; Zeng, L.; Zhao, Z.-J.; Gong, J., Applied Catalysis B: Environmental, 2017, 202, 683-694
Liang, Q.; Xiaofang, B., EPL (Europhysics Letters), 2011, 93, 57002
Littlewood, P.; Xie, X.; Bernicke, M.; Thomas, A.; Schomacker, R., Catalysis Today, 2015, 242, Part A, 111-118
Ma, H.; Zeng, L.; Tian, H.; Li, D.; Wang, X.; Li, X.; Gong, J., Applied Catalysis B: Environmental, 2016, 181, 321-331
Mueller, A. H., et al., Nanostructured Electrodes for Photochemical Hydrogen Generation. ECS Transactions, 2009, 19(35), 9-15
Mukasyan, A. S.; Rogachev, A. S.; Aruna, S. T., Advanced Powder Technology, 2015, 26, 954-976
Múnera, J. F.; frusta, S.; Cornaglia, L. M.; Lombardo, E. A.; Vargas Cesar, D.; Schmal, M., Journal of Catalysis, 2007, 245, 25-34
Muraleedharan Nair, M.; Kaliaguine, S., New Journal of Chemistry, 2016, 40, 4049-4060
Oemar, U.; Kathiraser, Y.; Mo, L.; Ho, X. K.; Kawi, S., Catalysis Science & Technology, 2016, 6, 1173-1186
Pakhare, D.; Spivey, J., Chemical Society Reviews, 2014, 43, 7813-7837
Pan, X.; Bao, X., Accounts of Chemical Research, 2011, 44, 553-562
Prieto, G.; Zečević, J.; Friedrich, H.; de Jong, K. P.; de Jongh, P. E., Nat Mater, 2013, 12, 34-39
Qu, B.; Lu, X.; Wu, Y.; You, X.; Xu, X., Nanoscale research letters, 2015, 10, 42
Shang, Z.; Li, S.; Li, L.; Liu, G.; Liang, X., Applied Catalysis B: Environmental, 2017, 201, 302-309
Sierra Gallego, G.; Mondragon, F.; Tatibouet, J. M.; Barrault, J.; Batiot-Dupeyrat, C., Catalysis Today, 2008, 133-135, 200-209
Singh, S.; Zubenko, D.; Rosen, B. A., ACS Catalysis, 2016, 6, 4199-4205
Talawar, M. B.; Sivabalan, R.; Mukundan, T.; Muthurajan, H.; Sikder, A. K.; Gandhe, B. R.; Rao, A. S., Journal of Hazardous Materials, 2009, 161(2), 589-607
Tappan, B. C.; Huynh, M. H.; Hiskey, M. A., Chavez, D. E., Luther, E. P.; Mang, J. T.; Son, S. F., Journal of the American Chemical Society, 2006, 128, 6589-6594
Tappan, B. C.; Steiner, S. A.; Luther, E. P., Angewandte Chemie International Edition, 2010, 49(27), 4544-4565
Theofanidis, S. A.; Galvita, V. V.; Poelman, H.; Marin, G. B., ACS Catalysis, 2015, 5, 3028-3039
Tsipouriari, V. A.; Verykios, X. E., Catalysis Today, 2001, 64, 83-90
Varma, A.; Rogachev, A. S.; Mukasyan, A. S.; Hwang, S., in Advances in Chemical Engineering, ed. W. James, Academic Press, 1998, vol. 24, pp. 79-226
Wang, S.; Lu, G. Q.; Millar, G. J., Energy & Fuels, 1996, 10, 896-904
Wang, R.; Xu, H.; Guo, Y.; Sa, R.; Shreeve, J. n. M., Journal of the American Chemical Society, 2010, 132, 11904-11905
Xie, T.; Shi, L.; Zhang, J.; Zhang, D., Chemical Communications, 2014, 50, 7250-7253
Zhang, S.; Yang, Q.; Liu, X.; Qu, X.; Wei, Q.; Xie, G.; Chen, S.; Gao, S., Coordination Chemistry Reviews, 2016, 307, Part 2, 292-312

1. A catalyst comprising discrete particles comprising a lanthanum-containing support material and nanoparticles of a transition metal excluding lanthanides and actinides or an oxide thereof, wherein said support material comprises lanthanum oxycarbonate in the form of La₂O₂CO₃ and La₂O(CO₃)₂, and said nanoparticles are impregnated within or attached to said support material.

2. The catalyst of claim 1, wherein:
(a) said nanoparticles are relatively uniformly distributed on said support material; or
(b) said catalyst does not comprise molecular carbon including fullerenes, single-walled carbon nanotubes, multi-walled carbon nanotubes, graphene, vitreous carbon, graphite, and amorphous carbon; or
(c) said nanoparticles comprise both said transition metal and said oxide thereof; or
(d) said transition metal is titanium, vanadium, manganese, iron, cobalt, nickel, copper, zinc, molybdenum, ruthenium, rhodium, palladium, tungsten, rhenium, osmium, iridium, or platinum.

3-5. (canceled)

6. The catalyst of claim 2, wherein said transition metal is nickel or iron.

7. The catalyst of claim 1, wherein said transition metal is nickel; and (a) the overall amount of said La₂O₂CO₃, La₂O(CO₃)₂, La₂O₃ and LaOCl is about 45-60%, preferably about 50-55%, by weight, of said catalyst; (b) the amount of said Ni is about 35-50%, preferably about 40-45%, by weight, of said catalyst; or (c) the amount of said NiO, when present, is about 5-15%, preferably about 8-12%, by weight, of said catalyst.

8. The catalyst of claim 7, wherein the overall amount of said La₂O₂CO₃, La₂O(CO₃)₂, La₂O₃ and LaOCl is about 50-52% by weight of said catalyst; the amount of said Ni is about 40-42% by weight of said catalyst; and the amount of said NiO is about 9-10% by weight of said catalyst.

9. The catalyst of claim 7, wherein (i) said support material comprises La₂O₂CO₃, La₂O(CO₃)₂, and said catalyst exhibits an increase of about 0.8 eV or more in the binding energy of the Ni3p XPS spectrum compared to that of unbound Ni.

10. A method for reforming of a hydrocarbon, comprising:
(i) reacting said hydrocarbon with carbon dioxide, in the presence of a catalyst according to claim 1, to thereby obtain hydrogen and carbon monoxide; or
(ii) reacting said hydrocarbon with steam, in the presence of a catalyst according to claim 1, to thereby obtain hydrogen and carbon dioxide; or
(iii) reacting said hydrocarbon with both carbon dioxide and steam, in the presence of a catalyst according to claim 1, to thereby obtain hydrogen and carbon monoxide.

11. The method of claim 10, wherein said hydrocarbon is methane.

12. The method of claim 10 or 11, wherein said transition metal is nickel.

13. A process for coating an inert ceramic monolith with a catalyst according to claim 1, said process comprising:
(i) activating the surface of said inert ceramic monolith;
(ii) mixing said catalyst with a metal oxide, a polysaccharide, polyethylene glycol, a polyvinyl compound, and water to form a slurry;
(iii) coating the activated ceramic monolith with said slurry; and
(iv) drying and then calcinating the coated ceramic monolith.

14. The process of claim 13, wherein:
(a) said inert ceramic monolith is alumina; or
(b) the inert ceramic monolith is activated in step (i) by cleaning with an acid; or
(c) the metal oxide mixed with said catalyst in step (ii) is alumina, colloidal alumina, pseudoboehmite, silica, colloidal silica, or sodium silicate; or
(d) the polysaccharide mixed with said catalyst in step (ii) is hydroxyalkyl cellulose; or
(e) the polyethylene glycol mixed with said catalyst in step (ii) has a molecular weight in a range of about 600 to about 6000 Da; or
(f) the polyvinyl compound mixed with said catalyst in step (ii) is polyvinyl alcohol, polyvinyl pyrrolidone, polyvinyl butyral, or polyvinyl chloride; or
(g) the activated ceramic monolith is coated with said slurry in step (iii) by dipping in said slurry.

15. (canceled)

16. The process of claim 14, wherein the inert ceramic monolith is activated in step (i) by cleaning with nitric acid; the metal oxide mixed with said catalyst in step (ii) is alumina; the polysaccharide mixed with said catalyst in step (ii) is hydroxypropyl cellulose; the polyethylene glycol mixed with said catalyst in step (ii) has a molecular weight of about 6000 Da; and said polyvinyl compound mixed with said catalyst in step (ii) is polyvinyl alcohol.

17. The process of claim 16, wherein the inert ceramic monolith is activated in step (i) by cleaning with nitric acid and then calcinated at about 550° C.; the concentration of the alumina mixed in step (ii) is 0.1-10 wt %; the concentration of the hydroxypropyl cellulose mixed in step (ii) is 0.01-5 wt %; the concentration of the polyethylene glycol mixed in step (ii) is 0.01-5 wt %; and the concentration of the polyvinyl alcohol mixed in step (ii) is 0.01-5 wt %.

18. The process of claim 13, wherein said transition metal is nickel.

19. A process for the preparation of a catalyst comprising discrete particles comprising a lanthanide-based support material and nanoparticles of a transition metal excluding lanthanides and actinides or an oxide thereof impregnated within or attached to said support material, said process comprising:
(i) mixing a complex of said lanthanide and an energetic nitrogen-rich ligand with a complex of said transition metal and the same or a different energetic nitrogen-rich ligand(s); and optionally an organic or inorganic oxidant, each in the form of a solid or semi-solid material, to obtain a homogeneous solid or semi-solid material;
(ii) optionally grinding and mixing said homogeneous solid or semi-solid material;
(iii) optionally pressing said homogeneous solid or semi-solid material into a form (pellet);
(iv) heating said optionally pressed homogeneous solid or semi-solid material at a temperature sufficient to combust said energetic nitrogen-rich ligand(s), but lower than the melting temperature of each one of said lanthanide and transition metal to thereby obtain a catalyst material;
(v) subjecting said catalyst material to a temperature sufficient to oxidize residual organic matter, but lower than the melting temperature of each one of said lanthanide and transition metal, in the flow of a gas mixture comprising O₂ and an inert gas selected from the group consisting of Ar, He and N₂; and
(vi) subjecting the product obtained in step (v) to a temperature sufficient to reduce the oxide of said transition metal obtained, but lower than the melting temperature of each one of said lanthanide and transition metal, in the flow of a gas mixture comprising O₂ and an inert gas selected from the group consisting of Ar, He and N₂, to thereby obtain said catalyst.

20. The process of claim 19, wherein:
(a) said inorganic oxidant is ammonium nitrate, ammonium dinitramide, or ammonium perchlorate; or said organic oxidant is a peroxide, trinitromethane salt, 2,2,2-trinitroethanol or a derivative thereof, 2,2-dinitromethane or a salt or derivative thereof, or 2,2-dinitroethanol or a salt or derivative thereof; or
(b) said lanthanide is lanthanum, cerium, praseodymium, neodymium, promethium, samarium, europium, gadolinium, terbium, dysprosium, holmium, erbium, thulium, ytterbium, or lutetium; or
(c) said transition metal is titanium, vanadium, manganese, iron, cobalt, nickel, copper, zinc, molybdenum, ruthenium, rhodium, palladium, tungsten, rhenium, osmium, iridium, or platinum; or
(d) said energetic nitrogen-rich ligand is triazole, tetrazole, N,N-bis(1H-tetrazole-5-yl)-amine (BTA), 5,5-diazotetrazolate triazole, tetrazine, a nitramine, a guanidine, a guanylurea, a nitroguanidine, a nitrourea, or an aminoguanidine; or
(e) said lanthanide complex of an energetic nitrogen-rich ligand is a La-BTA complex, and said transition metal complex of said energetic nitrogen-rich ligand is a Ni-BTA complex.

21. (canceled)

22. The process of claim 20, wherein said lanthanide is lanthanum, cerium, praseodymium, neodymium, promethium, samarium, or gadolinium.

23. The process of claim 22, wherein said lanthanide is lanthanum.

24. (canceled)

25. The process of claim 20, wherein said transition metal is nickel or iron.

26-27. (canceled)

28. The process of claim 19, for the preparation of a catalyst comprising discrete particles comprising a lanthanum-based support material and nickel nanoparticles impregnated within or attached to said support material, said process comprising:
(i) mixing a La-BTA complex with a Ni-BTA complex and optionally an organic or inorganic oxidant, each in the form of a solid or semi-solid material, to obtain a homogeneous solid or semi-solid material;
(ii) optionally grinding and mixing said homogeneous solid or semi-solid material;
(iii) optionally pressing said homogeneous solid or semi-solid material into a form (pellet);
(iv) heating said optionally pressed homogeneous solid or semi-solid material to about 350° C. to thereby combust said BTA ligand and said oxidant, if present, and consequently obtain a catalyst material;
(v) subjecting said catalyst material to a temperature of about 400° C., in the flow of a gas mixture comprising O₂ and an inert gas selected from the group consisting of Ar, He and N₂, to thereby oxidize said lanthanum; and
(vi) subjecting the product obtained in step (v) to a temperature of about 800° C., in the flow of a gas mixture comprising O₂ and an inert gas selected from the group consisting of Ar, He and N₂, to thereby reduce the nickel oxide obtained and consequently obtain said catalyst.

29. A catalyst comprising discrete particles comprising a lanthanide-based support material, and nanoparticles of a transition metal or an oxide thereof impregnated within or attached to said support material, obtained by the process of claim 19.

30. A method for reforming of a hydrocarbon, comprising:
(i) reacting said hydrocarbon with carbon dioxide, in the presence of a catalyst according to claim 29, to thereby obtain hydrogen and carbon monoxide; or
(ii) reacting said hydrocarbon with steam, in the presence of a catalyst according to claim 29, to thereby obtain hydrogen and carbon dioxide; or
(iii) reacting said hydrocarbon with both carbon dioxide and steam, in the presence of a catalyst according to claim 29, to thereby obtain hydrogen and carbon monoxide.

31. A lanthanum-N,N-bis(1H-tetrazole-5-yl)-amine (La-BTA) complex.

32. The La-BTA complex of claim 31 in pentahydrate form.

33. The process of claim 14, wherein:
(i) said inert ceramic monolith is γ-Al₂O₃, cordierite, mullite, or silicon carbide; or
(ii) the inert ceramic monolith is activated in step (i) by cleaning with the acid, and wherein the acid is selected from the group consisting of nitric acid, sulfuric acid, hydrochloric acid, and acetic acid; or
(iii) the inert ceramic monolith is activated in step (i) by cleaning with the acid, and then calcinating; or
(iv) the polysaccharide mixed with said catalyst in step (ii) is hydroxyalkyl cellulose and wherein the hydroxyalkyl cellulose is selected from the group consisting of hydroxypropyl cellulose and hydroxyethyl cellulose.

34. The process of claim 20, wherein said lanthanide complex of an energetic nitrogen-rich ligand is a La-BTA complex, and wherein the La-BTA complex is the La-BTA pentahydrate complex.

35. The catalyst of claim 1, wherein said support material further comprises lanthanum oxide (La₂O₃) or lanthanum oxychloride (LaOCl).
